(19) United States
(12) Patent Application Publication
(10) Pub. No.: US 2009/0327525 A1
(43) Pub. Date: Dec. 31, 2009

(54) METHOD FOR IMPROVING DATA WRITING SPEED OF A DISKLESS COMPUTER

(75) Inventor: Ming-Chao LEE, Pingjhen City (TW)

Correspondence Address: RABIN & Berdo, PC, 1101 14TH STREET, NW, SUITE 500, WASHINGTON, DC, 20005, US

(73) Assignee: JADE QUANTUM TECHNOLOGIES, INC., Taoyuan (TW)

(21) Appl. No.: 12/147,812

(22) Filed: Jun. 27, 2008

(51) Int. Cl. G06F 13/14

(52) U.S. Cl. 710/5

(57) ABSTRACT

A method for improving data writing speed of a diskless computer is applied to a diskless computer connecting to a remote server that has a disk drive and having a central processing unit (CPU), a host bus adapter (HBA) and a storage unit. The method has acts of retrieving writing data commands by the CPU from an operating system kernel executed by the CPU, writing the requested data to a storage unit in the diskless computer by the CPU, returning a response of finishing writing data to the operating system kernel by the CPU and writing data stored in the storage unit to the disk drive of the remote server by the CPU. Therefore, the operating system kernel receives the response of finishing writing data even though the loading of the network is heavy. Consequently, the speed of the diskless computer writing data increases.

### BACKGROUND OF THE INVENTION

1. Field of the Invention

The present invention relates to a method, and more particularly to a method for improving data writing speed of a diskless computer.

2. Description of Related Art

Many enterprises require multiple computers for staff to work and may use multiple individual personal computers (PCs) or a WAN boot personal computer (WBPC) service to build their computer systems. As described below, individual PCs suffer from data security and management problems and have a high per unit cost, so WBPC systems may be preferred. The WBPC service comprises a WAN boot server (WB server) and at least one WBPC. The at least one WBPC is a personal computer without any disk drives, and the operating system, application programs and user data of the WBPC are stored in disk drives in the WB server. The WBPC must have a host bus adapter (HBA) installed to connect to the WB server and access the disk drives in the WB server over the Internet with the Internet small computer system interface (iSCSI) protocol. The iSCSI protocol is a data transmission technique that transfers blocked data rather than conventional filed data. Data transferred by using the iSCSI protocol has higher data transmission efficiency. Furthermore, all data of the WBPC are centrally managed and stored so safety and security of the data of the WBPC are higher for the enterprise than multiple singular PCs.

Though the WBPC service has such advantages, it still has some shortcomings. When an operating system kernel of the WBPC executes an application program to access data, the WBPC has to connect to the WB server to access the disk drives in the WB server. However, because the operating system kernel of the WBPC that accesses data from the disk drive waits for the response from the disk drive, the executing application program will become idle until the operating system kernel receives the response from the disk drive. Therefore, some resources of the WBPC will be consumed waiting for the response from the disk drive so the data access efficiency of the WBPC is reduced, especially when many WBPCs try to access data in one disk drive in the WB server at the same time. The more WBPCs try to access data in one disk drive in the WB server, the higher loading of the disk drive results in lower data access efficiency and longer time for accessing data. The described shortcomings are the main reasons why the WBPC service cannot replace the individual PCs in enterprises.

To overcome the shortcomings, the present invention provides a method for improving data writing speed of a diskless computer to mitigate or obviate the aforementioned problems.

### SUMMARY OF THE INVENTION

The main objective of the invention is to provide a method for improving data writing speed of a diskless computer.

The method in accordance with the present invention is applied to a diskless computer connecting to a remote server that has at least one disk drive and having a central processing unit (CPU), a host bus adapter (HBA) and a storage unit. The method comprises acts of retrieving writing data commands by the CPU from an operating system kernel executed by the CPU, writing the requested data to a storage unit in the diskless computer by the CPU, returning a response of finishing writing data to the operating system kernel by the CPU and writing data stored in the storage unit to the at least one disk drive of the remote server by the CPU. Therefore, the operating system kernel receives the response of finishing writing data even though the loading of the network is heavy. Consequently, the speed of the diskless computer writing data increases.

The other objective of the present invention is to read data from the storage unit when the diskless computer tries to read data from the remote server if the requested data are stored in the storage unit. Therefore, the speed of the diskless computer reading data increases even though the loading of the network is heavy.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a first embodiment of a diskless computer that a method in accordance with the present invention is applied;

FIG. 2 is a functional block diagram of a second embodiment of a diskless computer that the method in accordance with the present invention is applied; and

FIG. 3 is a flow chart of the method in accordance with the present invention.

### DETAILED DESCRIPTION OF PREFERRED EMBODIMENT

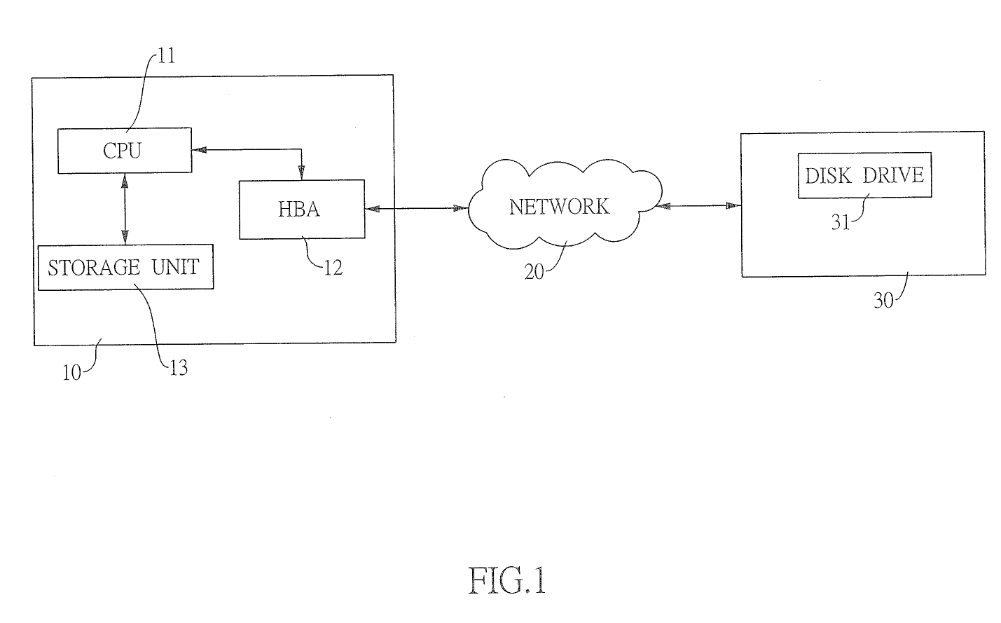

With reference to FIG. 1, a method for improving data writing speed of a diskless computer in accordance with the present invention is applied to a diskless computer (10).

The diskless computer (10) connects to a remote server (30) having at least one disk drive (31) over a network (20), such as the Internet. Each disk drive (31) may be but not limited to an integrated device electronics (IDE) disk drive, a small computer system interface (SCSI) disk drive, a serial advanced technology attachment (SATA) disk drive, a removable disk array, a storage area network (SAN) storage device or the like. The diskless computer (10) at least comprises a central processing unit (CPU) (11), a host bus adapter (HBA) (12) and a storage unit (13).

The CPU (11) is for executing an operating system kernel.

The HBA (12) is connected to the CPU (11) to allow the diskless computer (10) to connect to the remote server (30). Therefore, the diskless computer (10) accesses the at least one disk drive (31) in the remote server (30) over the network (20).

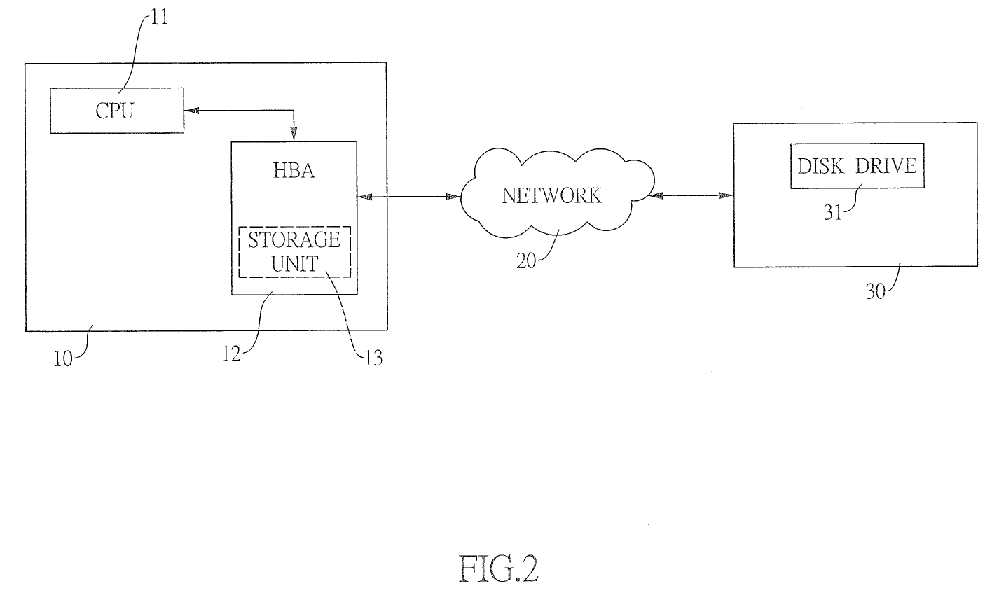

The storage unit (13) may be connected to the CPU (11) directly or indirectly. For example, the storage unit (13) may be a main memory of the diskless computer (10), such as synchronous dynamic random access memory (SDRAM), double data rate random access memory (DDR RAM) or the like, connected to the CPU (11) directly. Furthermore, with reference to FIG. 2, the storage unit (13) may be a flash memory additionally installed on the diskless computer (10) or memory in the HBA (12) connected to the CPU (11) indirectly.

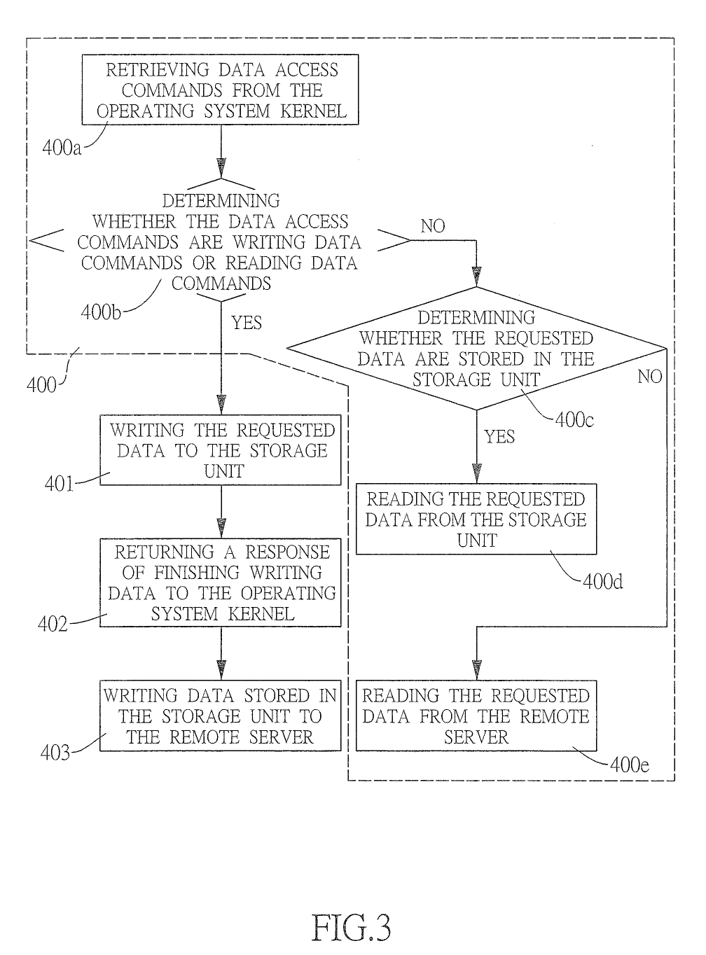

With further reference to FIG. 3, the method of the present invention comprises acts of retrieving writing data commands from the operating system kernel (400), writing the requested data to the storage unit (401), returning a response of finishing writing data to the operating system kernel (402) and writing data stored in the storage unit to the remote server (403).

The act of retrieving writing data commands from the operating system kernel (400) comprising the CPU (11) retrieving writing data commands from the operating system kernel. Furthermore, the act of retrieving writing data commands from the operating system kernel (400) may comprise sub-acts of retrieving data access commands from the operating system kernel (400a), determining whether the data access commands are writing data commands or reading data commands (400b), determining whether the requested data are stored in the storage unit (400c) and reading the requested data from the storage unit (400d). The sub-act of retrieving data access commands from the operating system kernel (400a) comprises the CPU (11) retrieving data access commands from the operating system kernel (400a) wherein the data access commands are either reading data commands or writing data commands.

The sub-act of determining whether the data access commands are writing data commands or reading data commands (400b) comprises the CPU (11) determining whether the data access commands are writing data commands.

The sub-act of determining whether the requested data are stored in the storage unit (400c) comprises the CPU (11) further determining whether the requested data are stored in the storage unit (13) when the data access commands are reading data commands.

The sub-act of reading the requested data from the storage unit (400d) comprises the CPU (11) reading the requested data from the storage unit (13) when the requested data are stored in the storage unit (13). Otherwise, a sub-act of reading the requested data from the remote server (400e) may be executed. The sub-act of reading the requested data from the remote server (400e) comprises the CPU (11) reading the requested data from the at least one disk drive (31) of the remote server (30) when the requested data are not stored in the storage unit (13). The act of writing the requested data to the storage unit (401) comprises the CPU (11) writing the requested data to the storage unit (13).

The act of returning a response of finishing writing data to the operating system kernel (402) comprises the CPU (11) returning a response of finishing writing data to the operating system kernel.

The act of writing data stored in the storage unit to the remote server (403) comprises the CPU (11) writing data stored in the storage unit (13) to the at least one disk drive (31) of the remote server (30) later, such as when the loading of the network (20) is not heavy or when the duration of storing data in the storage unit (13) is expired.

Based on the foregoing descriptions, when the diskless computer (10) wants to write data to the at least one disk drive (31) of the remote server (30), the requested data will be written to the storage unit (13) in the diskless computer (10) first. The speed of writing data to the storage unit (11) in the diskless computer (10) is faster than the speed of writing data to the at least one disk drive (31) in the remote server (30) over the network (20), especially when the loading of the network (20) is heavy. Furthermore, if requested data are stored in the storage unit (13), the CPU (11) will rather read the requested data from the storage unit (13) than from the at least one disk drive (31) of the remote server (30). Therefore, the speed of the diskless computer (10) reading and writing data will increase. A user of the diskless computer (10) will feel that the access efficiency of the diskless computer (10) is enhanced.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A method for improving data writing speed of a diskless computer comprising acts of:
retrieving writing data commands by a central processing unit (CPU) in a diskless computer from an operating system kernel executed by the CPU, wherein the diskless computer further comprises a host bus adapter (HBA) connected to the CPU to allow the diskless computer to connect to a remote server over a network;
writing the requested data to a storage unit in the diskless computer by the CPU;
returning a response of finishing writing data to the operating system kernel by the CPU; and
writing data stored in the storage unit to the at least one disk drive of the remote server by the CPU.

2. The method as claimed in claim 1, wherein the act of retrieving writing data commands further comprises sub-acts of:
retrieving data access commands from the operating system kernel by the CPU, wherein the data access commands are either reading data commands or writing data commands;
determining whether the data access commands are writing data commands or reading data commands;
determining whether the requested data are stored in the storage unit when the data access commands are reading data commands; and
reading the requested data from the storage unit when the requested data are stored in the storage unit.

3. The method as claimed in claim 2, wherein the act of retrieving writing data commands further comprises a sub-act of reading the requested data from the at least one disk drive of the remote server by the CPU when the requested data are not stored in the storage unit.

4. The method as claimed in claim 1, wherein the act of writing data stored in the storage unit to the at least one disk drive of the remote server by the CPU is executed when the loading of the network is not heavy.

5. The method as claimed in claim 2, wherein the act of writing data stored in the storage unit to the at least one disk drive of the remote server by the CPU is executed when the loading of the network is not heavy.

6. The method as claimed in claim 3, wherein the act of writing data stored in the storage unit to the at least one disk drive of the remote server by the CPU is executed when the loading of the network is not heavy.
